(19) United States
(12) Patent Application Publication
(10) Pub. No.: US 2020/0059838 A1
(43) Pub. Date: Feb. 20, 2020

(54) COMMUNICATION APPARATUS AND CONTROL METHOD FOR COMMUNICATION APPARATUS

(71) Applicant: SHARP KABUSHIKI KAISHA, Sakai City, Osaka (JP)

(72) Inventors: HIDEO NAMBA, Sakai City (JP); HIROMICHI TOMEBA, Sakai City (JP); TAKASHI YOSHIMOTO, Sakai City (JP)

(21) Appl. No.: 16/343,920

(22) PCT Filed: Aug. 29, 2017
(86) PCT No.: PCT/JP2017/030877

§ 371 Date: Apr. 22, 2019

(30) Foreign Application Priority Data
Oct. 24, 2016 (JP) 2016-207656

(51) Int. Cl. H04W 36/00; H04W 36/14; H04W 36/30

(52) U.S. Cl. CPC H04W 36/00837; H04W 36/30; H04W 36/0079; H04W 36/14

(57) ABSTRACT

That is, a handover condition suitable for a communication system may differ from a handover condition suitable for another communication system. Even in a case that the communication system performs the handover, the other communication system may fail to perform the handover, thus causing a communication to be interrupted until the appropriate handover is performed. A communication apparatus includes a communication controller configured to control at least one communication system used for communication with the plurality of communication apparatuses, and an interface unit configured to transmit and/or receive a signal according to the communication system. The communication controller initiates, in a case that a trigger for handover occurs in one of the plurality of communication apparatuses, a handover process of at least two of the plurality of communication apparatuses.

### TECHNICAL FIELD

The present invention relates to a communication apparatus and a control method for the communication apparatus.

### BACKGROUND ART

In recent years, the development of mobile communication systems has enabled data communication in a wide area. Common mobile communication systems use a communication system scheme referred to as a cellular scheme. A wide service area is divided into small areas (cells) to be managed, each small area being around a base station apparatus. In a case that a base station apparatus to which a terminal apparatus is connected detects that the terminal apparatus moves out of the area of a cell controlled by the base station apparatus, the base station apparatus performs a process (handover) of changing a connection destination of the terminal apparatus to a base station apparatus managing an adjacent cell.

On the other hand, data communication utilizing unlicensed frequency bands has been popular, and what we call private communication systems such as wireless LAN and Bluetooth (registered trademark) have been widely used. Such systems are used within an output range of radio waves permitted in a frequency band of interest and used within a short range. The wireless LAN is often used in order to obtain a relatively high transmission speed, and Bluetooth (registered trademark) is often used in order to reduce power consumption of apparatuses. Various other communication systems utilizing unlicensed frequency bands have been proposed, and a communication system is used that is selected according to allowable power consumption, a needed communication speed, a communication range, and the like. The communication range is significantly affected by the needed communication speed and the allowable power consumption. The practical communication distance of a private communication system is often short, and the communication distance often varies depending on the system.

Furthermore, as electronic devices including computers have become compact and sophisticated, terminal apparatuses used in mobile communication systems have also become compact and sophisticated. This allows a terminal apparatus to use multiple communication systems.

### CITATION LIST

### Non Patent Literature

NPL 1: 3GPP TS36 300 V10 6 0

NPL 2: IEEE 802.11-2012

NPL 3: Bluetooth SIG BLUETOOTH SPECIFICATION Version 4 2

### SUMMARY OF INVENTION

### Technical Problem

A private communication system may have a communication range significantly limited in a case of stand-alone usage. In a case that multiple apparatuses and multiple systems are used to increase the communication range, there is a problem in which the communication range, is different depending on the system. That is, a handover condition suitable for a communication system may differ from a handover condition suitable for another communication system. Even in a case that the communication system performs the handover, the other communication system may fail to perform the handover, thus causing a communication to be interrupted until the appropriate handover is performed.

In view of these circumstances, an object of the present invention is to provide a communication apparatus using one or more communication systems to communicate with multiple communication apparatuses, the communication apparatus being capable of efficiently performing, in a case that a handover is established between communication apparatuses, an appropriate handover that maintains quality of communication without affecting communications between other communication apparatuses, and to provide a control method.

### Solution to Problem

According to one aspect of the present invention, a communication apparatus is provided that communicates with a plurality of communication apparatuses, the communication apparatus including a communication controller configured to control at least one communication system used for communication with the plurality of communication apparatuses and an interface unit configured to transmit and/or receive a signal according to the communication system. In a case that a trigger for handover occurs in one of the plurality of communication apparatuses, the communication controller initiates a handover process of at least two of the plurality of communication apparatuses.

Furthermore, according to another aspect of the present invention, a communication apparatus is provided, wherein the at least one communication system includes a plurality of communication systems, and at least one of the at least two of the communication apparatuses of which the handover process is initiated, uses different communication systems before and after the handover process.

Furthermore, according to another aspect of the present invention, a communication apparatus is provided, wherein in a case that the trigger for handover occurs and a connection destination to be connected after the handover process is determined, whether the plurality of communication systems are available is determined, and the connection destination that uses an available system is selected.

Furthermore, according to another aspect of the present invention, a communication apparatus is provided, wherein in a case that the trigger for handover occurs, at least two of the plurality of communication apparatuses are selected based on a predetermined group.

Furthermore, according to another aspect of the present invention, a communication apparatus is provided, wherein in a case that the trigger for handover occurs to change a connection destination of the communication apparatus from a first communication apparatus included in the plurality of communication apparatuses to a second communication apparatus included in the plurality of communication apparatuses, the communication controller initiates the handover process of a third communication apparatus, among the plurality of communication apparatuses, that is connected to at least one of the second communication apparatus and the first communication apparatus.

Furthermore, according to another aspect of the present invention, a communication apparatus is provided, wherein in a case that the trigger for handover occurs to change a connection destination of a first communication apparatus included in the plurality of communication apparatuses to the communication apparatus, and information of a second communication apparatus included in the plurality of communication apparatuses is received from the interface unit, the communication controller accepts a connectivity request transmitted from the second communication apparatus to the communication apparatus.

Furthermore, according to another aspect of the present invention, a communication apparatus is provided, wherein in a case that the trigger for handover occurs to change a connection destination of the communication apparatus to a first communication apparatus included in the plurality of communication apparatuses, the communication controller initiates, after a predetermined period of time elapses, the handover process of at least one of a second communication apparatus and a third communication apparatus included in the plurality of communication apparatuses.

Furthermore, according to another aspect of the present invention, a communication apparatus is provided, wherein in a case that the trigger for handover occurs for a first communication apparatus connected to the subject communication apparatus to change a connection destination of the first communication apparatus to a second communication apparatus, the communication controller initiates the handover process of connecting, to the first communication apparatus, a third communication apparatus connected to the communication apparatus.

Furthermore, according to another aspect of the present invention, a communication apparatus is provided, wherein in a case that the trigger for handover occurs for the interface unit to change a connection destination to a first communication apparatus included in the plurality of communication apparatuses, the communication controller initiates the handover process of connecting, to the first communication apparatus, the communication apparatus and a second communication apparatus connected to the communication apparatus.

Furthermore, according to another aspect of the present invention, a communication apparatus is provided, wherein in a case that the trigger for handover occurs for a first communication apparatus, included in the plurality of communication apparatuses, that is a connection destination of the communication apparatus, to change a connection destination of the first communication apparatus to a second communication apparatus, the communication controller initiates the handover process of changing the connection destination of the communication apparatus to the second communication apparatus.

According to another aspect of the present invention, a control method is provided that is used in a communication apparatus for communicating with a plurality of communication apparatuses, the control method including initiating, in a case that a trigger for handover occurs in one of the plurality of communication apparatuses, a handover process of at least two of the plurality of communication apparatuses.

### Advantageous Effects of Invention

In a communication apparatus using one or more communication systems to communicate with multiple communication apparatuses, in a case that a handover is established, an appropriate handover that maintains quality of communication can be efficiently performed without affecting communications between other communication apparatuses.

### BRIEF DESCRIPTION OF DRAWINGS

FIG. 1 is a diagram illustrating an example arrangement of apparatuses according to a first embodiment.

FIG. 2 is a diagram illustrating another example arrangement of the apparatuses according to the first embodiment.

FIGS. 3A and 3B are diagrams, each illustrating an example of network connections among the apparatuses according to the first embodiment.

FIG. 4 is a sequence diagram illustrating an example procedure for connection state transition according to the first embodiment.

FIGS. 5A to 5C are diagrams, each illustrating an example configuration of a communication apparatus according to the first embodiment.

FIG. 6 is a flowchart illustrating an example process for a terminal apparatus according to the first embodiment.

FIG. 7 is a flowchart illustrating an example process for an access point according to the first embodiment.

FIG. 8 is a diagram illustrating another example process for the access point according to the first embodiment.

FIG. 9 is a flowchart illustrating an example process for a wireless tag according to the first embodiment.

FIG. 10 is a sequence diagram illustrating another example procedure for connection state transition according to the first embodiment.

FIG. 11 is a diagram illustrating an example operation of a handover between apparatuses according to a second embodiment.

FIG. 12 is a diagram illustrating an example operation of a handover between apparatuses according to a third embodiment.

FIGS. 13A and 13B are diagrams, illustrating examples of configurations of the apparatuses according to the third embodiment.

FIG. 14 is a sequence diagram illustrating an example procedure for connection state transition according to the third embodiment.

FIG. 15 is a diagram illustrating a system overview according to a fourth embodiment.

FIG. 16 is a diagram illustrating an example operation of a handover between apparatuses according to the fourth embodiment.

### DESCRIPTION OF EMBODIMENTS

### First Embodiment

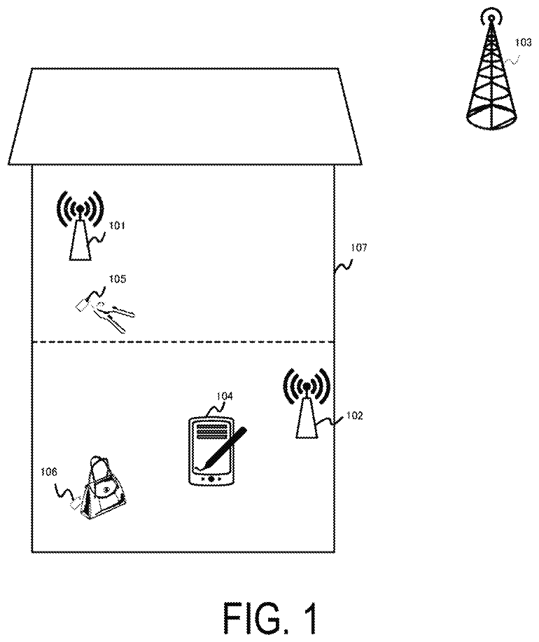

FIG. 1 illustrates an example overview of a radio communication system according to the present embodiment. An access point 101 and an access point 102 are control stations for a private communication system located in a building 107 and have different communication ranges in the building 107. A communication apparatus may be connected to any one of the access point 101 and the access point 102 in a case that the communication apparatus is located within a range where a communication range of the access point 101 overlaps with a communication range of the access point 102. A base station apparatus 103 is a Base Station apparatus (BS) used in a cellular communication system, and a terminal apparatus 104 is a Mobile Terminal (MT) including a function to communicate with the base station apparatus 103. The terminal apparatus 104 can be used in a private communication system besides the cellular communication system. The terminal apparatus 104 can communicate with the access point 101 and the access point 102 and further communicate with a wireless tag 105 and a wireless tag 106 described below. The wireless tag 105 is a wireless tag attached to a belonging, and the wireless tag 106 is a wireless tag attached to another belonging different from the belonging described above. These wireless tags can communicate with the access point 101, the access point 102, and the terminal apparatus 104 by using the private communication system. The access point 101 and the access point 102 may use a communication system with lower power consumption in order to communicate with the wireless tag 105 and the wireless tag 106. In this case, at least one of the access point 101 and the access point 102 may further include a communication system, having high power consumption, that is capable of communicating at a high speed, and may use the communication system capable of communicating at the high speed in a case of communicating with the terminal apparatus 104. The belonging to which the wireless tag 105 is attached is assumed to be located near the access point 101. The belonging to which the wireless tag 106 is attached is assumed to be located near the access point 102. Note that the terminal apparatus, the base station apparatus, the access points, and the wireless tags are hereinafter also referred to as communication apparatuses.

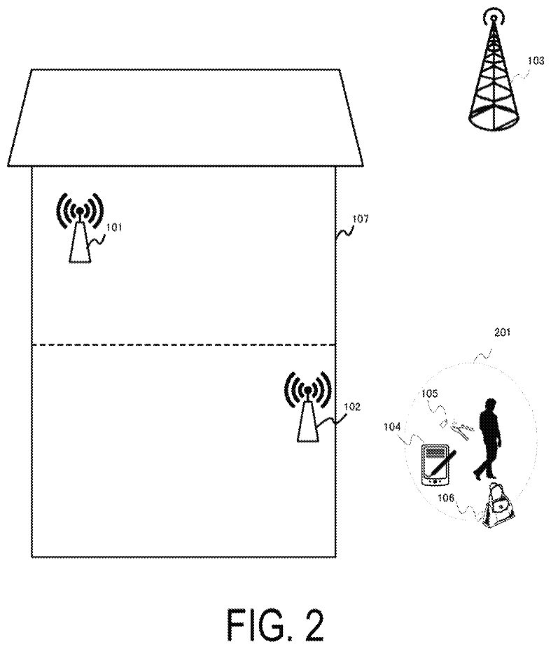

FIG. 2 is a diagram illustrating another example of a communication system according to the present embodiment. FIG. 2 illustrates a state transition from the state illustrated in FIG. 1 to the state in which two belongings are taken out along with the terminal apparatus 104. The terminal apparatus 104, the wireless tag 105 attached to the belonging, and the wireless tag 106 attached to the other belonging are located within a periphery 201 of a person that has taken out the terminal 104. At this time, a distance between the range 201 and the access point 101 or the access point 102, or a communication system used determines whether the access point 101 or 102 can communicate with the terminal apparatus 104, the wireless tag 105 attached to the belonging, and the wireless tag 106 attached to the other belonging. In a case that a distance from the periphery 201 to the access point 101 or the access point 102 is longer than or equal to a predetermined value, the wireless tag 105 attached to the belonging and the wireless tag 106 attached to the other belonging can communicate only with the terminal apparatus 104. However, before the distance reaches the predetermined value, the wireless tag 105 attached to the belonging, the wireless tag 106 attached to the other belonging, and the terminal apparatus 104 may not always maintain the access point 101 or the access point 102 as a connection destination. Thus, in a case that each of the apparatuses independently performs a handover process, the apparatuses may fail to communicate with one another. In order to prevent such a problem, in a case that a trigger to perform a handover occurs in one of the communication systems, the handover is performed for all the related apparatuses including apparatuses utilizing the other communication systems.

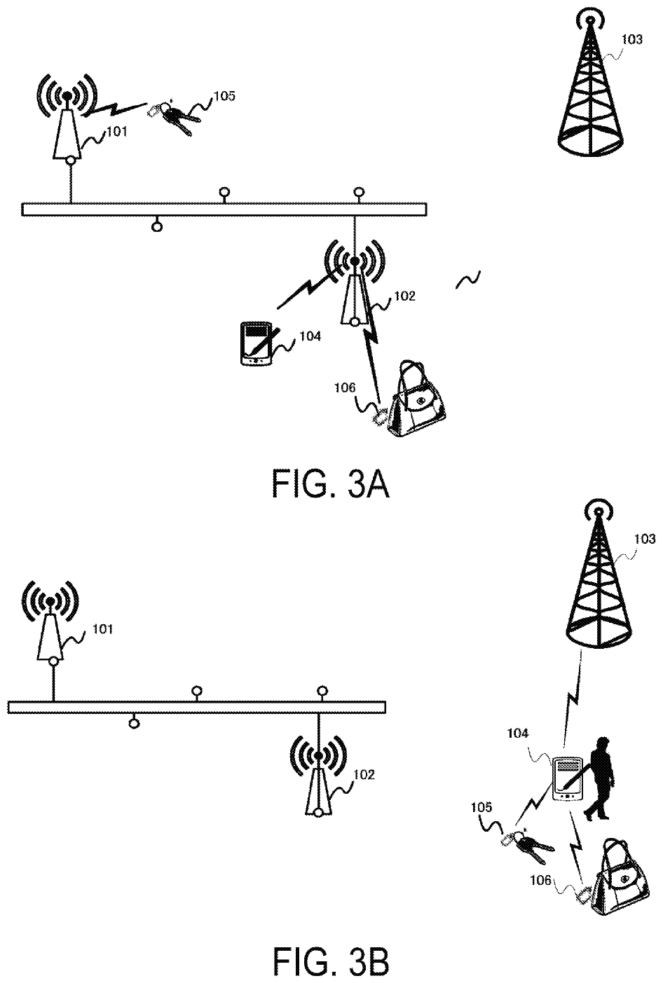

FIGS. 3A and 3B are diagrams, each illustrating an example of network connections among the apparatuses according to the present embodiment. FIG. 3A is a diagram illustrating network connections in a case that all the apparatuses are located in the building 107. FIG. 3B is a diagram illustrating network connections in a case that the terminal apparatus 104, and the wireless tag 105 and the wireless tag 106 attached to the belongings are taken out of the building. In FIG. 3A, the access point 101 and the access point 102 are connected by a wired network. Although, in the present embodiment, the access points are connected by the wired network, the present invention is not limited to this and a radio network may be used for the connection. The wireless tag 105 is connected to the access point 101. The wireless tag 106 is connected to the access point 102. The communication system used for connections between the wireless tags 105 and 106 and the access points 101 and 102, respectively, covers one floor in the building and may include a communication system with low power consumption, for example, Bluetooth (registered trademark) Basic Rate (BR) or Enhanced Data Rate (EDR). The terminal apparatus 104 is connected to the access point 102. The communication system used to connect the terminal apparatus 104 and the access point 102 may include a high-speed communication system, for example, a wireless LAN typified by IEEE 802.11n standard. The terminal apparatus 104 can communicate with the wireless tag 105 and the wireless tag 106 via the access point 102. The wired network connecting the access point 101 and the access point 102 may be connected to the Internet. In this case, the terminal apparatus 104 can access the Internet via the access point 102.

As illustrated in FIG. 3B, the wireless tag 105 and the wireless tag 106 are connected to the terminal apparatus 104. The communication system used for connecting the wireless tags 105 and 106 and the terminal apparatus 104 may include a communication system, used for short range communication, that have low power consumption, for example, Bluetooth (registered trademark) Low Energy (BLE). The terminal apparatus 104 may be connected to the cellular base station apparatus 103 and connected to the Internet via the base station apparatus 103.

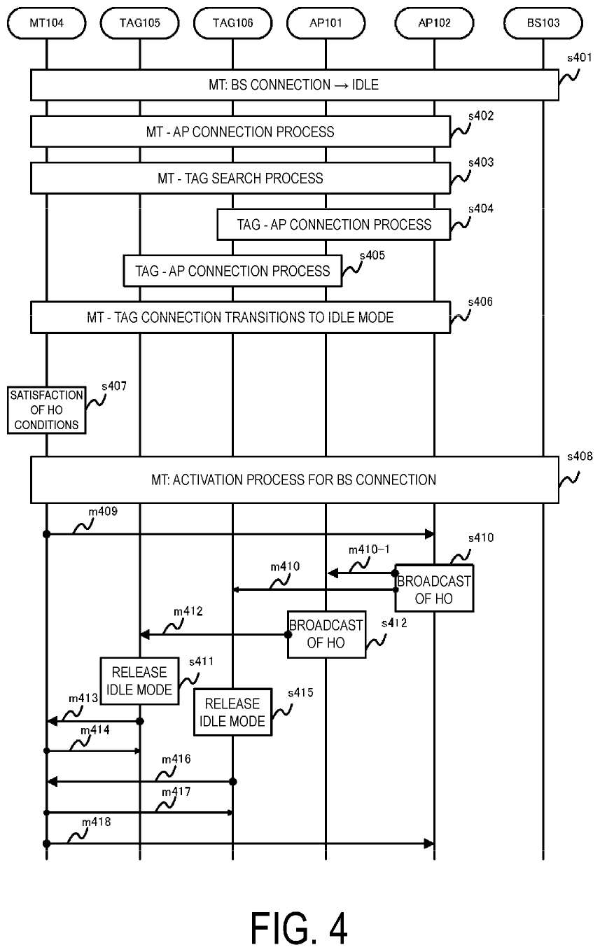

FIG. 4 is a sequence diagram illustrating an example procedure for connection state transition according to the present embodiment. FIG. 4 is a sequence diagram illustrating an example procedure in which one trigger causes a state transition from the connection state in FIG. 3A to the connection state in FIG. 3B. It is assumed that a sequence starts immediately after apparatuses are powered on. In a step s401, the terminal apparatus 104 (MT 104) initiates a process of connecting to the base station apparatus 103 (BS 103) and subsequently transitions to a communication idle state. In this state, it is necessary to be capable of starting communication without any error in a case that communication data is actually generated. For example, the state is equivalent to a camped state to which the terminal apparatus transitions after the terminal apparatus is registered with the cellular network. Subsequently in a step s402, the terminal apparatus 104 checks whether any access point of the private communication system is available, and performs a process of connecting to the access point 102 (AP 102) that can be used according to the embodiment. For example, the process is equivalent to an association process in accordance with an IEEE 802.11 standard. In the IEEE 802.11 standard, an authentication process, an exchange of an encryption key, and the like are subsequently performed to enable data communication via the access point 102. Subsequently in a step s403, the terminal apparatus 104 requests the access point 102 to perform a process of searching for a wireless tag attached to the belonging. The access point 102 and the access point 101 (AP 101) connected to the access point 102 then search for a searchable wireless tag. In a step s404, the access point 102 searches for a wireless tag located around the access point 102 and connects to the wireless tag that can be found. Examples of a method for searching for a wireless tag includes a Service Discovery Procedure (SDP) used for Bluetooth (registered trademark). After the access point 102 operates as a master, a device that has been found by using the SDP is determined to be a wireless tag. Furthermore, the access point 102 can connect to the wireless tag in a case that a pairing operation has been finished between the wireless tag and the access point 102. In a case that the pairing operation has not been finished, the access point 102 may notify, to the terminal apparatus 104, that a wireless tag for which the pairing operation has not been finished has been found, and a pairing operation between the access point 102 and the newly found wireless tag may be urged. Furthermore, the access point 102 performs a notification to the access point 101 to request the access point 101 to search for a wireless tag. In a step s405, the access point 101 searches for a wireless tag located around the access point 101 and connects to the wireless tag that has been found. For this procedure, the procedure denoted as s405 can be used. The access point 101 notifies the access point 102 of information about the wireless tag which has been searched and successfully connected. For example, the information about the wireless tag may include any one of a MAC address used by the wireless tag, a list of services supported by the wireless tag, a Universally Unique Identifier (UUID), and the like. The access point 101, having received the notification, then notifies the terminal apparatus 104 of the information about the wireless tag found by the access point 102 and the information about the wireless tag found by the access point 101. After receiving the notification of the information about the wireless tags found by the access point 101 and the access point 102, in a step s406 the terminal apparatus 104 checks whether the wireless tag notified can communicate with the terminal apparatus 104, and causes the state of communication with the wireless tag that can communicate with the terminal apparatus 104 to transition to an idle state. For example, the terminal apparatus 104 checks whether the MAC address of the wireless tag notified has been paired, and in a case that the MAC address has been paired, the wireless tag is handled as a wireless tag that can be connected to the terminal apparatus and the connection with the wireless tag is automatically accepted. In a case that the wireless tag has not been paired, the terminal apparatus 104 performs the paring process. The wireless tag is temporarily disconnected and a connection with the wireless tag is automatically accepted in a case of a new connectivity request. In a case that pairing is performed, a message of the pairing to be performed may be indicated on the terminal apparatus 104 to obtain a confirmation from the user. A state that has transitioned up to this step is equivalent to the state in FIG. 3A. The terminal apparatus 104, the wireless tag 105 (TAG 105), and the wireless tag 106 (TAG 106) can communicate with one another via the access point 101 and the access point 102.

The terminal apparatus 104 monitors quality of communication with the access point 102, and also monitors another radio system to repeatedly determine whether to change the connection destination from the access point 102 to the other radio system. In the present embodiment, an example is illustrated in which the connection destination is switched from the access point 102 to the cellular base station apparatus 103. In a step s407, the terminal apparatus 104 determines that the quality of communication with the access point 102 does not satisfy a predetermined level of quality and a communication with the base station apparatus 103 is possible, and determines that conditions for switching the connection destination to the base station apparatus 103 are satisfied.

In the step s407, in a case that the conditions for changing the connection destination of the terminal apparatus 104 to the base station apparatus 103 are satisfied, the terminal apparatus 104 activates, in a step s408, a connection with the base station apparatus 103. For example, the terminal apparatus 104 initiates a connection procedure to the base station apparatus, configures a bearer for communication, and activates the bearer. In a case that the step s408 is successful, the terminal apparatus 104 causes itself to be ready to receive the connectivity request from the wireless tag. For example, the terminal apparatus 104 transitions to an advertising state of BLE so as to be ready to receive the connectivity request. Furthermore, the terminal apparatus 104 transmits a message m409 to the access point 102 to cause the wireless tag to initiate a process of changing the connection destination to the terminal apparatus 104. The message m409 may include information for identifying the wireless tag that is caused to change the connection destination. For example, the message m409 may include the MAC addresses of the wireless tag 105 and the wireless tag 106. The access point 102 receives the message m409, and in a step s410, broadcasts a message m410 for indicating, to the wireless tag, to change the connection destination to the terminal apparatus 104. At the same time, the terminal apparatus 104 also transmits a message m410-1 to the access point 101 to cause the access point 101 to initiate a procedure for indicating, to the wireless tag, to change the connection destination to the terminal apparatus 104. The message m410 may be broadcasted, according to a broadcast scheme, to all the wireless tags connected to the access point 102, or may be notified, according to a unicast scheme, to each of the wireless tags connected to the access point 102. The access point 101 receives the message m410-1, and in a step s412, broadcasts a message m412 for indicating, to the wireless tag connected to the access point 101, to change the connection destination to the terminal apparatus 104. A method for broadcasting the message may be similar to the method in the step s410. The message m410 and the message m412 may include the MAC address of the wireless tag to which the access point indicates to change the connection destination. The MAC address may include only the MAC address of the wireless tag connected to each access point or the MAC addresses of all the wireless tags to which the access points indicate to change the connection destination. The message m410-1 may be similar to the message m409 or may correspond to the message m409 without information such as the MAC address of the wireless tag connected to an access point 1/101.

The wireless tag 105 receives the message m410, and in a step s411, causes the radio system used between the wireless tag and the terminal apparatus 104 to operate, starts communication with the terminal apparatus 104, and starts a process of terminating communication with the access point 101. After starting the step s411, the wireless tag 105 transmits a message m413 to the terminal apparatus 104 for a connectivity request to the terminal apparatus 104. For example, the wireless tag 105 may transition to an initializing state to transmit a response to an advertising packet transmitted from the terminal apparatus 104 in an advertising state, and transition to a state in which the wireless tag 105 is connected to the terminal apparatus 104. The terminal apparatus 104, having received the message m413, configures communication with the wireless tag 105 and transmits a message m414 to the wireless tag 105. For example, the terminal apparatus 104 may activate a future exchange procedure of BLE to provide a message m414. Furthermore, the wireless tag 106 receives the message m412, and in a step s415, causes the radio system used between the wireless tag 106 and the terminal apparatus 104 to operate, starts communication with the terminal apparatus 104 and starts a process of terminating communication with the access point 102. After starting the step s415, the wireless tag 106 transmits a message m416 to the terminal apparatus 104 for a connectivity request to the terminal apparatus 104. The terminal apparatus 104, having received the message m416, configures communication with the wireless tag 106 and transmits a message m417 to the wireless tag 106. The processing of the step s415, and the contents of the message m416 and the message m417 may be similar to the processing of the procedure s411, and the contents of the message m413 and the message m414, respectively. After starting the steps s411 and s415, the wireless tag 105 and the wireless tag 106 respectively terminate the communications with the access point 101 and the access point 102. The disconnection process may be started before the connectivity request to the terminal apparatus 104 is performed, may be started at the same time when the connectivity request to the terminal apparatus 104 is performed, or may be started after the connectivity request is successful. A disconnection process may be started before the connectivity request to the terminal apparatus 104 succeeds, and then the connectivity request may fail. In such a case, a procedure for recovering the connection to the access point 101 or the access point 102 may be started. The step s411 and the step s412 may be performed in order or may be performed in parallel. Either the step s411 or the step s412 may be started first, and either a message exchange started by the procedure s411 or a message exchange started by the procedure s412 may be completed first.

After the terminal apparatus 104 transmits the message m409, and communication is established between the wireless tag 105 and the wireless tag 106, the terminal apparatus 104 transmits a message m418 to the access point 102 to terminate the communication with an access point 2/102. This leads to the state in FIG. 3B. The terminal apparatus 104 may determine that the handover has failed in a case that communication with the wireless tag 105 or the wireless tag 106 has not been established within a predetermined time period after a transmission of the message m409. In a case of determining that a handover has failed, the terminal apparatus 104 may perform an operation of notifying the user of the failure of the handover. Examples of an operation to be performed may be displaying the failure of the handover on a screen, generating an alert sound, and causing the terminal apparatus 104 itself to vibrate.

In FIG. 4, a handover of the terminal apparatus 104 connected to the access point 102 to the cellular communication system is a trigger for the handover of the wireless tag 105 and 106 connected to the access point 102 to the terminal apparatus 104. However, the trigger for the handover is not limited to this. A handover of the terminal apparatus 104 to a particular base station apparatus (or access point) can be a trigger. For example, a handover of the terminal apparatus 104 to the base station apparatus 103 located at a particular position can be a trigger for the handover of the wireless tags 105 and 106 connected to the access point 102 to the terminal apparatus 104. Alternatively, a handover of the terminal apparatus 104 to the access point 101 located at a particular position can be a trigger for the handover of the wireless tags 105 and 106 connected to the access point 102 to the terminal apparatus 104.

Furthermore, handover of the terminal apparatus 104 performed at a predetermined time (timer) can be used as a trigger. For example, an alarm time configured by the terminal apparatus 104 can be a timing for the handover of the wireless tags 105 and 106 connected to the base station apparatus 103 and the access point 102 to the terminal apparatus 104. The alarm time may cover a given time range.

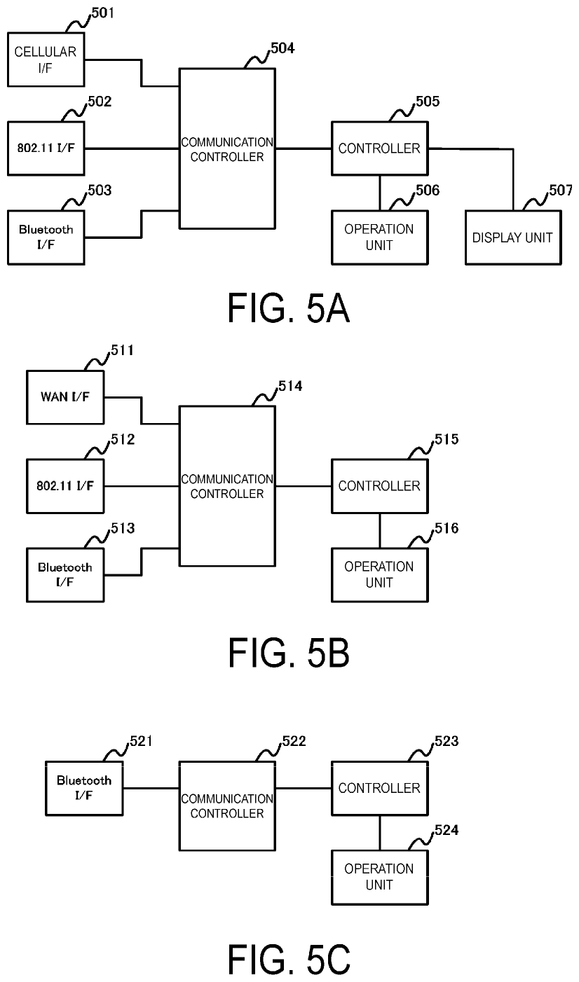

FIGS. 5A to 5C are diagrams, each illustrating an example of a general configuration of a communication apparatus according to the present embodiment. FIG. 5A illustrates an example of the general configuration of the terminal apparatus 104, FIG. 5B illustrates an example of the general configuration of the access point, and FIG. 5C illustrates an example of the general configuration of the wireless tag. First, FIG. 5A will be described. An interface unit 501 is an interface for communication with the cellular communication system, the interface unit 502 is an interface for a first private communication system such as an IEEE 802.11 system, and the interface unit 503 is an interface for a second private communication system such as Bluetooth (registered trademark). The interface units transmit and receive signals in accordance with the respective communication systems. The first private communication system and the second private communication system may each include multiple communication modes, and for example, the second private communication system may include a Basic Rate (BR) mode of Bluetooth (registered trademark) and a Bluetooth (registered trademark) Low Energy (BLE) mode. A communication controller 504 controls the interface units 501 to 503 to transmit and/or receive communication data used in each of the communication systems used by the respective interface units and cause each of the communication systems to perform various measurements. Furthermore, the communication controller 504 performs exchange of control messages with other communication apparatuses, the control messages including a control message for handover. The controller 505 includes an operation unit 506 and a display unit 507. The controller 505 generates data to be communicated through each communication system based on various measurement results and an operating status of each communication system obtained from the communication controller 504, receives data, and selects one of the communication systems to be used. The operation unit 506 performs an operation for inputting, from the outside of the terminal apparatus 104, operation data to the controller 505. The display unit 507 displays data generated by the controller 505. FIG. 5B will now be described. An interface unit 511 is a Wide Area Network (WAN) interface connected to the Internet via a wired network. An interface unit 512 is an interface for a first private communication system. An interface unit 513 is an interface for a second private communication system. The interface unit 512 uses a communication system similar to the communication system used by the interface unit 502. The interface unit 513 uses a communication system similar to the communication system used by the interface unit 503. A communication controller 514 controls the interface units 511 to 513 to transmit and/or receive communication data used in each of the communication systems used by the respective interface units and to cause each of the communication systems to perform various measurements. A controller 515 includes an operation unit 513, and generates data to be communicated through each communication system based on various measurement results and an operating status of each communication system obtained from the communication controller 514, receives data, and selects one of the communication systems to be used. The operation unit 516 is an operation unit configured to input, from the outside of the access point, operation data to the controller 515. Finally, FIG. 5C will be described. An interface unit 521 is an interface for a second private communication system and uses a communication system similar to the communication system used by the interface unit 503. A communication controller 522 controls the interface unit 521 to transmit and/or receive communication data used in the communication system used by the interface unit 521, and causes the communication system to perform various measurements. A controller 523 generates data to be communicated based on various measurement results and the operating status of each communication system obtained from the communication controller 522, receives data, and controls the communication system to be used.

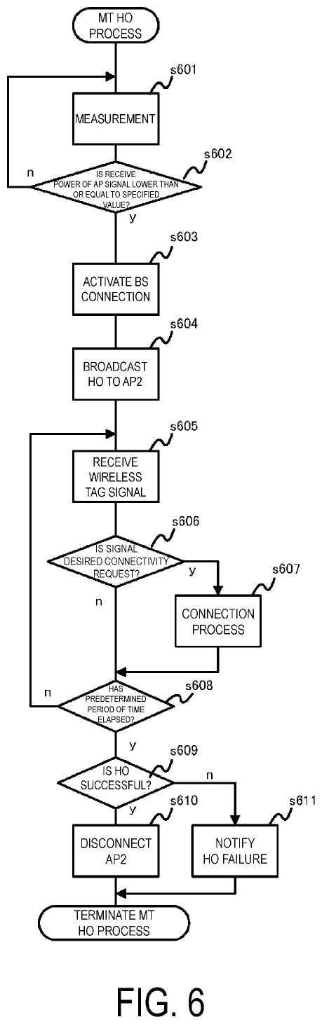

FIG. 6 is a flowchart illustrating an example process for the terminal apparatus according to the present embodiment. The handover of the terminal apparatus 104 may be performed in accordance with the sequence illustrated in FIG. 4, and an example of an operation flow of the controller 505 in such a case will now be described with reference to FIG. 6. The flow illustrates an example procedure of the transition from the state in FIG. 3A to the state in FIG. 3B. In a step s601, the terminal apparatus 104 measures reception quality of a signal transmitted by the access point 102 in the first private communication system. The terminal apparatus 104 determines whether a value of the reception quality of the signal measured in step s602 is smaller than or equal to a predetermined value, and in a case that the value of the reception quality is not smaller than or equal to the predetermined value, the process returns to s601 again. In a case that the value of the reception quality is smaller than or equal to the predetermined value, the process proceeds to s603. The case in which the process proceeds to s603 corresponds to satisfaction of handover trigger conditions of s407 in FIG. 4. In the step s603, the connection between the terminal apparatus 104 and the base station apparatus 103 is activated. An example activation of the connection may be performed in the process of s408 described above. Subsequently in a step s604, the terminal apparatus 104 indicates to the access point 102 to broadcast handover to the wireless tag. This notification may include information for identifying the wireless tag of which the handover process is to be executed. This step corresponds to m409 in FIG. 4. The terminal apparatus 104 subsequently receives, in s605, a signal transmitted from the wireless tag. The process proceeds to s607 in a case that the signal received in s605 is a connectivity request signal transmitted from the wireless tag of which the handover process is to be performed. Otherwise the process proceeds to s608. In a step s607, the terminal apparatus 104 configures a communication resource between the terminal apparatus 104 and the wireless tag that has transmitted the connectivity request, and transmits a message corresponding to the connectivity request, to the wireless tag that has transmitted the connectivity request. In step s608, the terminal apparatus 104 determines whether a predetermined period of time has elapsed since the terminal apparatus 104 indicated the handover to the wireless tag in s604. In a case that the predetermined period of time has not elapsed, the process returns to s605, otherwise the process proceeds to s609. In step s609, the terminal apparatus 104 checks whether connectivity requests have been transmitted from all the wireless tags expecting handover. In a case that the connectivity requests have been transmitted from all the wireless tags expecting the handover, the terminal apparatus 104 determines that the handover process is successful, and the process proceeds to s610, otherwise the process proceeds to s611. In step s610, the terminal apparatus 104 performs a process of disconnection from the access point 102, and terminates the handover process of the terminal apparatus 104. In step s611, the terminal apparatus 104 utilizes the display unit 507 to indicate a failure of the handover process, and terminates the handover process. In this flow, in a case that the handover process is not successful, the communication between the access point 102 and the terminal apparatus 104 is not disconnected. However, after the failure of the handover process is indicated on the display unit 507, the communication between the access point 102 and the terminal apparatus 104 may be disconnected. Furthermore, in a case that multiple wireless tags are present and that the handover processes of some of the multiple wireless tags have succeeded, whereas the handover processes of the remaining wireless tags have failed, the display unit 507 may indicate a list of the wireless tags of which the handover processes have succeeded and a list of the wireless tags of which the handover processes have failed.

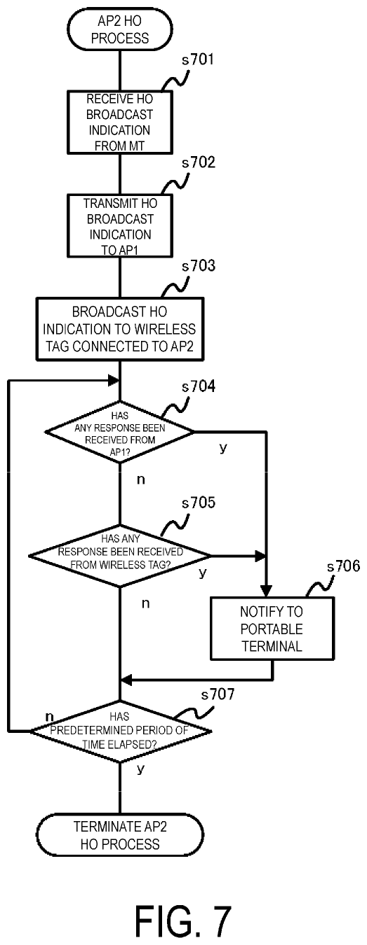

FIG. 7 is a flowchart illustrating an example process for the access point according to the present embodiment. The handover of the access point 2/102 may be performed in accordance with the sequence illustrated in FIG. 4. An example operation flow of the controller 515 in such a case will be described with reference to FIG. 7. First, in a step s701, the access point 102 receives, from the terminal apparatus 104, an indication to the wireless tag to change a connection destination. Then, in a step s702, the access point 102 transmits, to the access point 101, the indication to the wireless tag to change the connection destination. Subsequently, in a step s703, the access point 102 broadcasts, to the wireless tag connected to the access point 102, an indication to change the connection destination to the terminal apparatus 104. The order of the steps s702 and s703 may be reversed. In a case that a content received in s701 includes information for identifying a wireless tag of which a connection destination is to be changed, the broadcasting operation to wireless tags may indicate to the wireless tag only to change the connection destination or perform a transmission to the wireless tag only. Subsequently, in a step s704, the access point 102 determines whether a response corresponding to s702 is transmitted from the access point 101 to the access point 102. In a case that the response has been transmitted, the process proceeds to s706, otherwise the process proceeds to s705. Subsequently, in a step s705, the access point 102 determines whether a response corresponding to s703 is transmitted from the wireless tag to the access point 102. In a case that the response has been transmitted, the process proceeds to s706, otherwise the process proceeds to s707. In a step s706, the access point 102 notifies the terminal apparatus 104 of the response received in s704 or s705, and the process proceeds to s707. In a step s707, the access point 102 determines whether a predetermined period of time has elapsed since the change of the connection destination was notified in s702 and s703. In a case that the predetermined period of time has not elapsed, the process returns to s704, and in a case that the predetermined period of time has elapsed, the handover process is terminated.

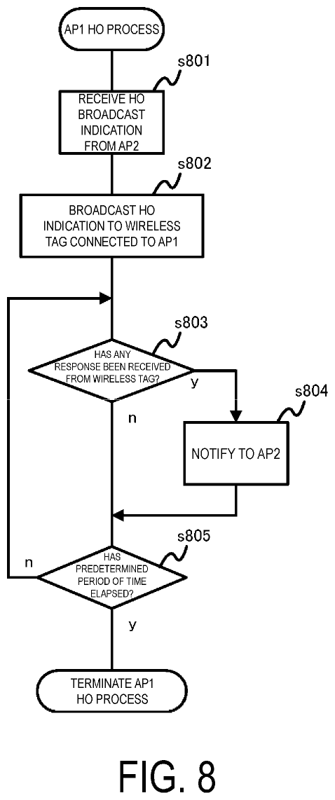

FIG. 8 is a flowchart illustrating another example process for the access point according to the present embodiment. The handover of the access point 101 may be performed in accordance with the sequence illustrated in FIG. 4. An example of an operation flow of the controller 515 in such a case will be described with reference to FIG. 8. First, in a step s801, the access point 101 receives, from the access point 102, an indication to the wireless tag to change a connection destination. Then, in a step s802, the access point 101 transmits the indication to change the connection destination to the wireless tag connected to the access point 101. In a case that a content received in s801 includes information for identifying a wireless tag of which the connection destination is to be changed, the access point 101 may transmit the information to cause only the wireless tag to change the connection destination. Subsequently, in a step s803, the access point 101 determines whether the wireless tag has transmitted a response corresponding to s802. In a case that the response has been transmitted, the process proceeds to s804, otherwise the process proceeds to s805. In a step s804, the access point 101 transmits, to the access point 102, the content of the response received from the wireless tag. Subsequently, in a step s805, the access point 101 determines whether a predetermined period of time has elapsed since the indication to change the connection destination was transmitted in s802. The access point 101 returns to s803 in a case that the predetermined time has not elapsed and terminates the handover process in a case that the predetermined time has elapsed.

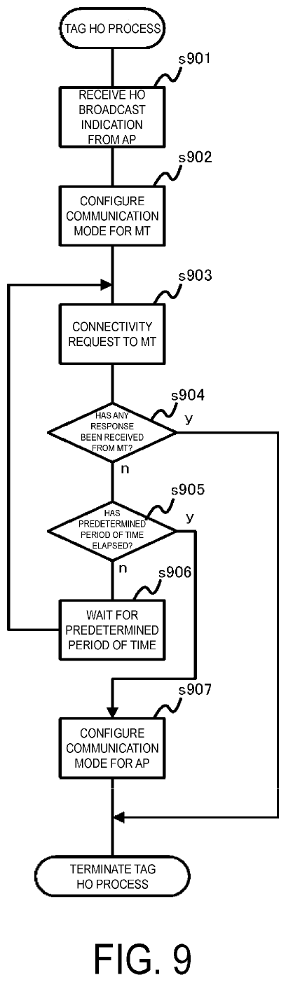

FIG. 9 is a flowchart illustrating an example process for the wireless tag according to the present embodiment. The handover of the wireless tags 105 and 106 may be performed in accordance with the sequence illustrated in FIG. 4. An example of an operation flow of the controller 523 in such a case will be described with reference to FIG. 9. First, in a step s901, the wireless tags 105 and 106 receive an indication to change a connection destination from one of the access points to the terminal apparatus 104. At this time, the interface unit of the private communication system is configured to be in a mode for communication with the access point. Then, in a step s902, the interface unit of the private communication system is configured to be in a mode for transmission to the terminal apparatus 104. Subsequently, in a step s903, the wireless tags 105 and 106 transmit a connectivity request to the terminal apparatus 104. This operation corresponds to the message m413 and the message m416 in FIG. 4. Then, in a step s904, the wireless tags 105 and 106 determine whether the terminal apparatus 104 to which the connectivity request has been transmitted has responded. In a case that the terminal apparatus 104 has responded, the handover process is terminated, otherwise the process proceeds to s905. In a step s905, the wireless tags 105 and 106 determine whether the number of attempts of connectivity request has reached a predetermined number of times. In a case that the number of attempts has reached the predetermined number of times, the process proceeds to s907, and in a case that the number of attempts is less than the predetermined number of times, the process proceeds to s906. In a step s906, the wireless tags 105 and 106 wait for a predetermined period of time until the next attempt, and subsequently returns to s903. In a step s907, the interface unit of the private communication system is configured to be in a mode for communication with the access point, and the handover process is terminated.

The operations of the apparatuses described above allow the sequence illustrated in FIG. 4 to be performed. This enables the handover process to be performed for multiple apparatuses with different communication ranges by using one trigger. The quality of communication can thus be improved. FIG. 4 illustrates an example sequence of the transition from the state in FIG. 3A to the state in FIG. 3B. In contrast, the state in FIG. 3B may transition to the state in FIG. 3A. For example, this corresponds to a case of transition from the state in FIG. 2 where the belonging has been taken out to the state in FIG. 1 where the belonging has been taken into the building.

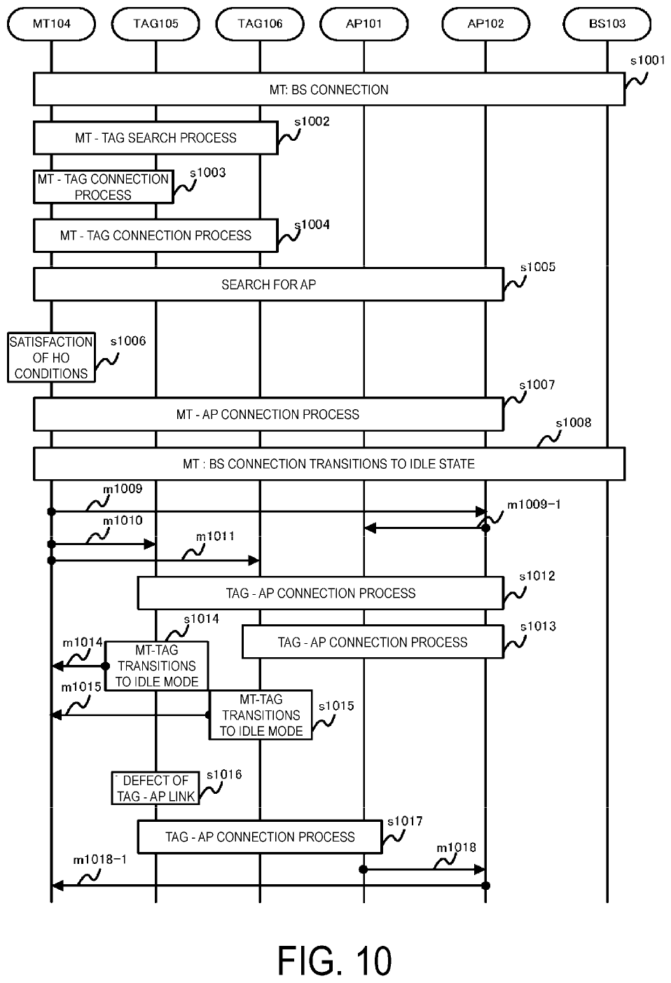

FIG. 10 is a sequence diagram illustrating another example procedure for connection state transition according to the present embodiment. FIG. 10 is a sequence diagram illustrating an example sequence for the transition from the state in FIG. 3A to the state in FIG. 3B. A start point in the sequence diagram in FIG. 10 corresponds to a case where the apparatuses are located as illustrated in FIG. 2 and powered on. First, the terminal apparatus 104 is powered on, and then, a step s1001 is performed to connect the terminal apparatus 104 to the base station apparatus 103. Then, in a step s1002, the terminal apparatus 104 activates a tag search process to search for a wireless tag located around the terminal apparatus 104. Here, it is assumed that two wireless tags, which are a wireless tag 105 and a wireless tag 106, are found. Then, in a step s1003, the terminal apparatus 104 performs a process of connecting to the wireless tag 105. In a step s1004, the terminal apparatus 104 performs a process of connecting to the wireless tag 106. Successful connections to the wireless tags result in a state equivalent to the state in FIG. 3B.

In the state equivalent to the state in FIG. 3B, in a step s1005, the terminal apparatus 104 searches for an access point located around the terminal apparatus 104. The terminal apparatus 104 is moved with the wireless tag 105 and the wireless tag 106 being located proximately to the terminal apparatus 104. Here, the terminal apparatus 104 approaches the access point 102, and becomes in a state in which the terminal apparatus 104 can connect to the access point 102. This satisfies handover conditions, and the terminal apparatus 104 generates a trigger for handover in a step s1006. In a case that the trigger for handover is generated, the terminal apparatus 104 performs a process of connecting to the access point 102 in a step s1007. In a case that the process succeeds, in a step s1008, the terminal apparatus 104 causes the state of connection to the base station apparatus 103 to transition to an idle state. The terminal apparatus 104 subsequently transmits a message m1009 to the access point 102 to notify that the wireless tag 105 and the wireless tag 106 are to be connected to a network connected to the access point 102. The access point 102 thus recognizes that the access point 102 may receive a connectivity request from the wireless tag 105 or the wireless tag 106. The access point 102, having received the message m1009, transmits, to the access point 101, a message m1009-1 with a content equivalent to the content of the message m1009 to notify that the access point 101 may receive a connectivity request from the wireless tag 105 or the wireless tag 106.

The terminal apparatus 104, having transmitted the message m1009, subsequently transmits a message m1010 to the wireless tag 105 to notify that the wireless tag 105 is to be connected to the access point 2/102. Besides information for indicating the access point 102, the message m1010 may include information for indicating the access point 101 connected to the same network. Furthermore, the terminal apparatus 104 transmits a message m1011 to the wireless tag 106 to notify that the wireless tag 106 is to be connected to the access point 102. Besides information for indicating the access point 102, the message m1011 may include information for indicating the access point 101 connected to the same network. The wireless tag 105 receives the message m1010, and in a step s1012, performs a process of connecting to the access point 102. This connection may be similar to, for example, the connection in step s404 in FIG. 4. Furthermore, the wireless tag 106 receives the message m1011, and in a step s1013, performs a process of connecting to the access point 102. This connection may also be similar to, for example, the connection in step s404 in FIG. 4 as is the case with step s1012. The wireless tag 105, successfully connected to the access point 102 in a step s1012, initiates, in a step s1014, a process of setting the state of connection to the terminal apparatus 104 to an idle mode. During this step, the wireless tag 105 transmits a message m1014 to the terminal apparatus 104 to notify that the wireless tag 105 is to set the connection to the terminal apparatus 104 to an idle mode. The idle mode is not particularly specified but may be what is called a standby state, such as a state where power needed to maintain the connection is low, and transmission and/or reception of data is limited, and a state where a particular procedure is needed before transmission and/or reception of data. Furthermore, the wireless tag 106, successfully connected to the access point 102 in the step s1013, similarly initiates, in a step s1015, a process of setting the state of connection to the terminal apparatus 104 to an idle mode. During this step, the wireless tag 106 transmits a message m1015 to the terminal apparatus 104 and the like to notify that the wireless tag 2/106 is to set the state of connection to the terminal apparatus 104 to an idle mode. The terminal apparatus 104, having received the message m1014 and the message m1015, may communicate with the wireless tag 105 or the wireless tag 106 via the access point 102. As described above, one trigger allows multiple devices to perform the handover operation. In the present embodiment, a case is described where the two wireless tags approach the range of the building 107, and both of the two wireless tags approach the access point 102. However, in a case that the two wireless tags respectively approach the access point 101 and the access point 102, the connection process may allow the wireless tag approaching the access point 101 to be connected to the access point 101, and allow the wireless tag approaching the access point 102 to be connected to the access point 102. The terminal apparatus 104 may communicate with the respective wireless tags via the access point 101 and the access point 102.

Subsequently, the wireless tag 105 moves from a position near the access point 102 to a position near the access point 101, and the distance between the wireless tag 105 and the access point 102 is increased, thus degrading communication quality during the movement. In a step s1016, the wireless tag 105 detects a communication link defect between the wireless tag 105 and the access point 102. In the subsequent step s1017, the wireless tag 105 performs the process of connecting to the access point 101. The access point 101, having accepted the connection, transmits a message m1018 to the access point 102 to notify that the access point 101 has accepted the connection from the wireless tag 105. The access point 102, having received the message m1018, transmits a message m1018-1 to the terminal apparatus 104 to notify that the wireless tag 105 has connected to the access point 101. The terminal apparatus 104, having received the message m1018-1, may communicate with the wireless tag 105 via the access point 102 and the access point 101. This state is equivalent to the state in FIG. 3A, enabling a change of state between FIG. 3A and FIG. 3B.

In a modification of the present embodiment, the access point or the like may be used to estimate the position of the terminal apparatus 104, and a trigger for handover may be generated within a particular range of the building 107. For example, in order to generate a trigger for handover in a case that the terminal apparatus 104 approaches a position near a doorway such as an entrance, the access point 102 may be located at a position near the doorway. The terminal apparatus 104 may measure receive power of a signal, such as a beacon signal, that is transmitted by the access point 102 to determine that the terminal apparatus 104 has approached the access point 102. Alternatively, the terminal apparatus 104 and the access point 102 may exchange transmission packets by Network Time Protocol (NTP) or a similar method and measure a propagation delay between the terminal apparatus 104 and the access point 102 to determine that the terminal apparatus 104 has approached the access point 102. Furthermore, multiple access points may be used to measure the propagation delay between the terminal apparatus 104 and each of the access points, thus allowing the position of the terminal apparatus 104 to be measured to determine that the terminal apparatus 104 has approached the vicinity of the doorway.

### Second Embodiment

In the first embodiment, apparatuses to be handed over are all of the apparatuses of which handovers are possible. In the present embodiment, the apparatuses to be handed over are selected from the apparatuses of which handovers are possible.

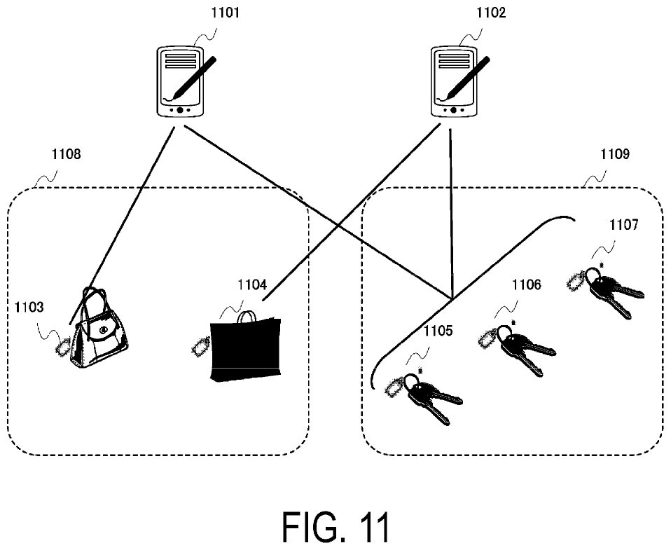

FIG. 11 is a diagram illustrating an example handover operation of each apparatus according to the present embodiment. An example operation will be described with reference to FIG. 11. In the example, apparatuses to be handed over are selected from apparatuses of which handovers are possible. A first group 1108 represents a group including wireless tags 1103 and 1104. A second group 1109 represents a group including wireless tags 1105, 1106, and 1107. Each of the apparatuses included in the first group is associated with a particular terminal apparatus. It is assumed that at least one of the apparatuses included in the second group is to be handed over. In the present embodiment, the wireless tag 1103 is associated with a terminal apparatus 1101, and the wireless tag 1104 is associated with a terminal apparatus 1102. As for the wireless tags 1105, 1106, and 1107 that are included in the second group, in a case that a trigger for handover occurs and the handover of at least one of the wireless tags is successful, the process is considered to be a normal handover process.

Configurations of the apparatuses and a sequence during handover may be applied that are substantially similar to the configurations of the apparatuses and the sequence during handover in the first embodiment. For example, in a case that the terminal apparatus 1101 follows the sequence in FIG. 4, each access point may transmit messages corresponding to the messages m410 and m412 to the wireless tags 1103, 1105, 1106, and 1107. In this case, multiple wireless tags among the wireless tags 1105, 1106, and 1107 included in the second group may perform connectivity requests to the terminal apparatus 1101. The terminal apparatus 1101 may indicate, on the display unit of the terminal apparatus 1101, that the multiple wireless tags have requested the handover. Furthermore, the terminal apparatus 1101 may be caused to select (configure) the wireless tag to hand over. For the wireless tags not to be handed over, the terminal apparatus 1101 may refuse the received connectivity requests to cause the wireless tags to maintain the connections to the access points.

Furthermore, For example, in a case that the terminal apparatus 1102 follows the sequence in FIG. 10, the message m1109 for notifying the access point of information about the wireless tags may include information about the wireless tag 1104 included in the first group, and the wireless tags included in the second group, for example, the wireless tags 1105 and 1106 currently connected to the terminal apparatus 1102.

The operation described above allows, in a case that the handover process of multiple apparatuses is performed by using one trigger, the handover process of some of the apparatuses of which the handovers are possible can be performed.

### Third Embodiment

Now, a third embodiment will be described. Multiple terminal apparatuses used in the cellular communication system may each use a communication link involving no base station apparatus (the communication link may be referred to as direct communication, a direct link, a side link, and the like). A trigger for handover occurring in one of the terminal apparatuses in such a case causes the handovers of the multiple terminal apparatuses in the embodiment.

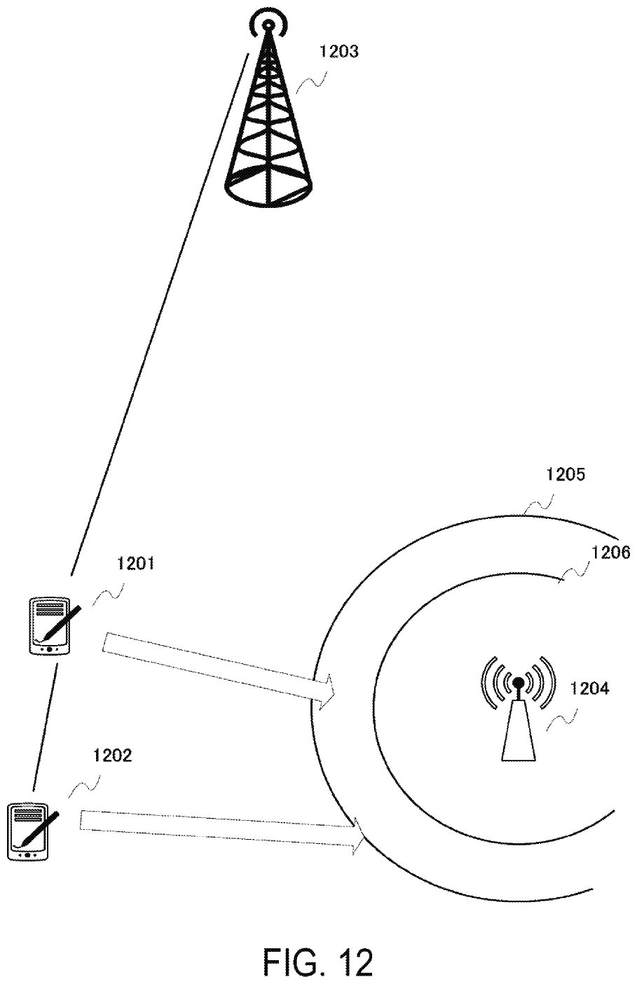

FIG. 12 is a diagram illustrating an example handover operation of each apparatus according to the present embodiment. Terminal apparatuses 1201 and 1202 can be connected to a cellular radio communication system and a radio communication system other than the cellular radio communication system, for example, a private communication system such as wireless LAN. A base station apparatus 1203 is a base station apparatus to which the terminal apparatuses 1201 and 1202 connect in a case of communicating by using a cellular communication system. An access point 1204 is a device to which the terminal apparatuses 1201 and 1202 connect in a case of using a radio communication system other than the cellular communication system. Here, in the cellular communication system, the terminal apparatuses can communicate directly with each other. In the case of the direct communication, each of the terminal apparatuses receives, from the base station apparatus 1203, information about radio resources for the direct communication (a time, a frequency, and the like that may be used for the direct communication), and based on the information, transmits information to the other terminal apparatus. The access point 1204 may use one or more radio communication systems. In a case that the radio communication systems use different frequencies, the coverage of the access point 1204 can vary depending on the radio communication system. For example, the access point 1204 can use two wireless LANs. One of the wireless LANs may use a 2.4 GHz band, and the other wireless LAN may use a 5 GHz band. In general, in radio communication, as a frequency used becomes lower, a possible communication range increases. In the present embodiment, the range 1205 is a communication range of the wireless LAN using the 2.4 GHz band, and the range 1206 is a communication range of the wireless LAN using the 5 GHz band. In the present embodiment, the wireless LANs use the IEEE 802.11 standards. As a communication range becomes longer, the number of interfering objects increases accordingly, thus a communication speed may decrease. In contrast, in a case of a short communication range, the number of interfering objects decreases, thus a communication speed may increase. The communication range and the communication speed may be in a trade-off relationship.

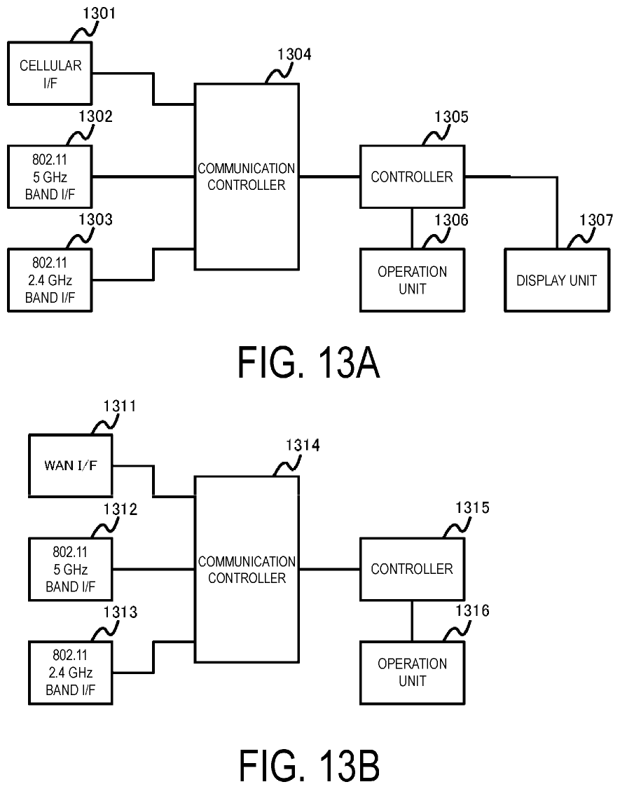

FIGS. 13A and 13B are diagram illustrating examples of configurations of the apparatuses according to the present embodiment. FIG. 13A illustrates an example of a configuration of the terminal apparatuses 1201 and 1202. The interface unit 1301 is an interface for communication with the cellular communication system. The interface unit 1302 is an interface for connecting to the wireless LAN system with a 5 GHz band. The interface unit 1303 is an interface for connecting to the wireless LAN system with a 2.4 GHz band. A communication controller 1304 controls the interface units 1301 to 1303 to transmit and/or receive communication data used in the communication systems used by the respective interface units and to cause each of the communication systems to perform various measurements. A controller 1305 includes an operation unit 1306 and a display unit 1307. The controller 1305 generates data to be communicated through each communication system based on various measurement results and an operating status of each communication system obtained from the communication controller 1304, receives data, and selects one of the communication systems to be used. The operation unit 1306 inputs operation data to the controller 1305 from the outside of the terminal apparatus. The display unit 1307 displays data generated by the controller 1305. FIG. 13B illustrates an example configuration of the access point 1203. The interface unit 1311 is a WAN interface connected to the Internet via a wired network. The interface unit 1312 is an interface for the wireless LAN system with a 5 GHz band. The interface unit 1313 is an interface for the wireless LAN system with a 2.4 GHz band. The interface unit 1312 uses a communication system similar to that used by the interface unit 1302. The interface unit 1313 uses a communication system similar to that used by the interface unit 1303. A communication controller 1314 controls interface units 1311 to 1313 to transmit and/or receive communication data used in each of the communication systems used by the respective interface units and to cause each of the communication systems to perform various measurements. A controller 1315 includes an operation unit 1316, and generates data to be communicated through each communication system based on various measurement results and the operating status of each communication system obtained from the communication controller 1314, receives data, and selects one of the communication systems to be used. The operation unit 1316 inputs operation data to the controller 1315 form the outside of the access point.

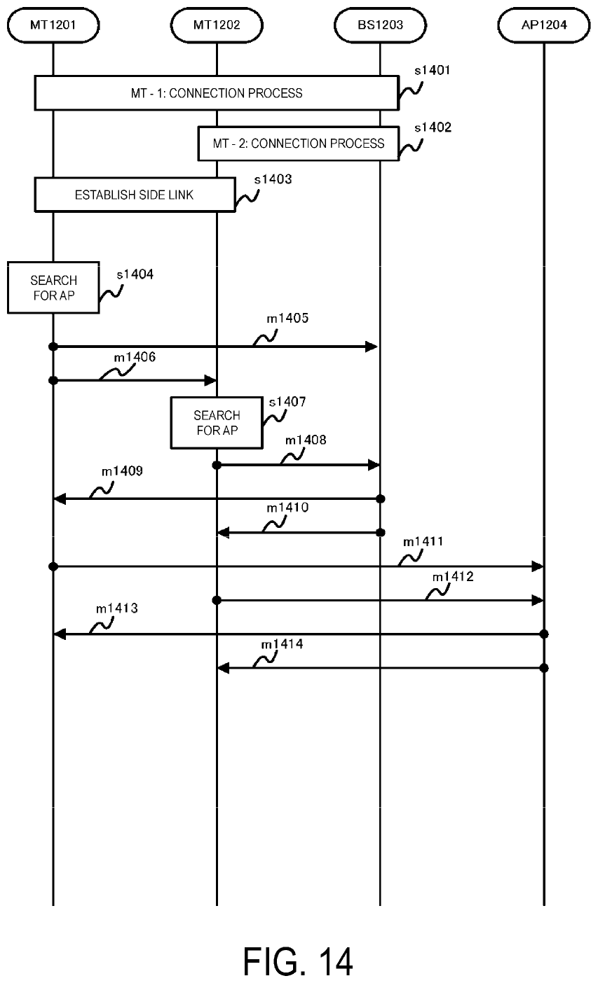

FIG. 14 is a sequence diagram illustrating an example procedure for connection state transition according to the present embodiment. FIG. 14 illustrates an example sequence. In the sequence, the terminal apparatuses 1201 and 1202 in direct communication with each other as illustrated in FIG. 12 approach the access point 1204. The terminal apparatus 1201 determines that the terminal apparatus 1201 can communicate with the access point 1204, which is a trigger for handover to cause the handovers of the two terminal apparatuses. The sequence starts with connections of the respective terminal apparatuses 1201 (MT1201) and 1202 (MT1202) to the base station apparatus 1203 (BS1203). The connections are started, for example, immediately after the terminal apparatuses are powered on. First, in a step s1401, the terminal apparatus 1201 performs a process of connecting to the base station apparatus 1203 based on a signal transmitted by the base station apparatus 1203. Furthermore, similarly in a step s1402, the terminal apparatus 1202 performs a process of connecting to the base station apparatus 1203 based on a signal transmitted by the base station apparatus 1203. After the terminal apparatuses 1201 and 1202 connect to the base station apparatus 1203, in a step s1403, the terminal apparatus 1201 and the terminal apparatus 1202 establish a link for the direct communication. At this time, either one or both of the terminal apparatuses 1201 and 1202 may request to the base station apparatus 1203 radio resources for the direct communication. The radio resources for the direct communication may be allocated by the base station apparatus 1203, or the radio resources for the direct communication may be determined based on a predetermined method. After the radio resources for the direct communication are determined, the terminal apparatuses 1201 and 1202 may use the direct communication to confirm that the terminal apparatuses 1201 and 1202 can communicate with each other or may confirm configurations of the radio resources for the direct communication via the terminal apparatus 1203. As for the radio resources used for the direct communication, both the terminal apparatuses 1201 and 1202 may use the same radio resources or use different radio resources for transmission to each other. FIG. 12 illustrates a state in which the process has proceeded up to a step s1403. Then, the terminal apparatuses 1201 and 1202 move.

The terminal apparatus 1201 approaches the access point 1204 (AP1204), and in a step s1404, as a result of a search for an access point with which the terminal apparatus 1201 can communicate, causes the access point 1204 to be a candidate. At this time, for faster communication, the communication range 1205 of the 2.4 GHz band may not be treated as a possible communication range, and in a case that the terminal apparatus 1210 moves into the communication range 1206 of the 5 GHz band, the access point 1204 may be caused to be a candidate. In a case that the 2.4 GHz band is allowed, the movement of the terminal apparatus 1210 into the communication range 1205 of the 2.4 GHz band may cause the access point 1204 to be a candidate. A particular frequency, for example, a 5 GHz band may be unavailable. For example, in a case that only the frequencies of which the outdoor use is prohibited are available or in a situation where a radar wave has been detected, the particular frequency may be excluded from the candidates. In a case that the candidate is determined in a step s1404, the terminal apparatus 1201 transmits a message m1405 to the base station apparatus 1203 to notify the presence of an access point suitable for communication. Furthermore, the terminal apparatus 1201 transmits a message m1406 to the terminal apparatus 1202 to notify the presence of the access point suitable for communication. Either of the message m1405 and the message m1406 may be transmitted first. The message m1406 may be transmitted by using the radio resources for direct communication. The message m1405 and the message m1406 may include information regarding the access point 1204 that is caused to be a candidate and include, for example, information regarding a Service Set IDentifier (SSID), a MAC address, a frequency channel, a frequency band used, and receive power of the access point 1204. Furthermore, the message m1405 and the message m1406 may include information regarding the frequency channel used by the access point 1204, information regarding access points, for example, causing noise power or interference, and information regarding a signal related to power of an interference signal and occupancy time.

The terminal apparatus 1202 receives the message m1406, and in a step s1407, searches for an access point with which the terminal apparatus 1202 can communicate. At this time, the information included in the message m1406 may be used to search for an access point. For example, in a case that the message m1406 includes information regarding the frequency channel and SSID used by the access point, an access point may be searched based on these pieces of information. After searching for an access point with which the terminal apparatus 1202 can communicate in a step s1407, the terminal apparatus 1202 transmits a message m1408 to the base station apparatus 1203 to notify the presence of the access point suitable for communication. The message m1408 may include information regarding the access point with which the terminal apparatus 1202 can communicate and include, for example, information regarding a Service Set IDentifier (SSID), a MAC address, a frequency channel, a frequency band used, and receive power of the access point 1204. Furthermore, in a case of selecting a candidate for the access point, the terminal apparatus 1202 may use the 2.4 GHz band that enables a wide coverage, instead of the 5 GHz band that enables faster communication. A communication environment may be different for each terminal apparatus. For example, in a case that the distance from the terminal apparatus 1201 to the access point 1204 slightly differs from the distance from the terminal apparatus 1202 to the access point 1204, the connection destinations of the terminal apparatus 1201 and the terminal apparatus 1202 can be changed at similar timings.

The base station apparatus 1203, having received the message m1405, transmits a message m1409 to the terminal apparatus 1201 to indicate to the terminal apparatus 1201 to perform a connectivity request to the access point 1204. Furthermore, the base station apparatus 1203, having received the message m1408, transmits a message m1410 to the terminal apparatus 1202 to indicate to the terminal apparatus 1202 to perform a connectivity request to the access point 1204. A transmission order of the message m1409 and the message m1410 is not limited, and either of the messages m1409 and m1410 may be transmitted first. The base station apparatus 1201, having received the message m1409, transmits a message m1411 to the access point 1204 to notify the connectivity request to the access point 1204. The terminal apparatus 1201 may include, in the message m1411, information about the terminal apparatus 1202 to which the message m1406 is to be transmitted. Besides the message m1411, the terminal apparatus 1201 may transmit, to the access point 1204, a message for notifying information about the terminal apparatus 1202 to which the message m1406 is to be transmitted. Furthermore, the terminal apparatus 1202, having received the message m1410, transmits a message m1412 to the access point 1204 to notify the connectivity request to the access point 1204. Either of the message m1411 and the message m1412 may be transmitted first. The access point 1204, having received the message m1411, transmits a message m1413 to the terminal apparatus 1201 to notify that the access point 1204 has allowed the connection of the terminal apparatus 1201. Furthermore, the access point 1204, having received the message m1412, transmits a message m1414 to the terminal apparatus 1202 to notify that the access point 1204 has allowed the connection of the terminal apparatus 1202. In a case of having previously received the information about the terminal apparatus 1202, the access point 1204 may preferentially accept the connection of the terminal apparatus 1202. The terminal apparatus 1201 and the terminal apparatus 1202 that are allowed to connect to the access point 1204 communicate via the access point 1204. At this time, the state of the connection to the base station apparatus 1203 may transition to an idle state, or only particular information may be transmitted to the base station apparatus 1203. Furthermore, the communication that has been using the radio resources for direct communication may be switched to a communication via the access point 1204.

Performing the sequence as described above allows the connection destinations of multiple terminal apparatuses to be changed (handover) by using one trigger for handover.

### Fourth Embodiment

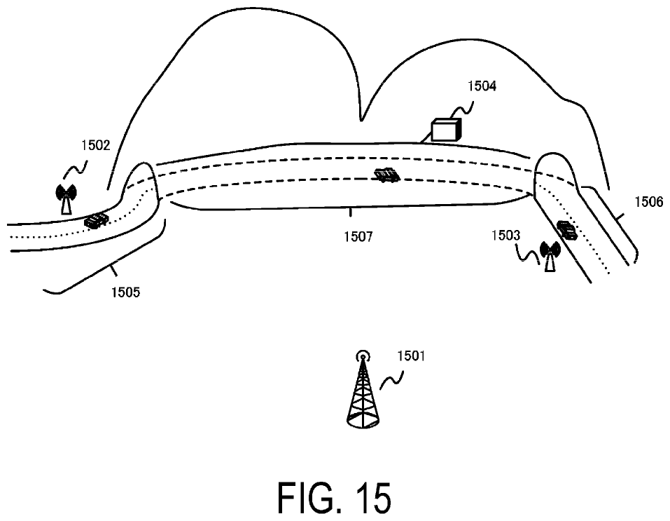

An embodiment will now be described in which, after a predetermined period of time has elapsed since a trigger for handover occurred, multiple connection destinations are connected. FIG. 15 is a diagram illustrating an overview of a system according to the present embodiment. The system in FIG. 15 includes a base station apparatus 1501 for a wide area, roadside stations 1502 and 1503, located on the roadside of a road, each of which has a limited coverage, an in tunnel station 1504 having a coverage of the inside of a tunnel (the inside of a blocking space) which cannot be reached by a radio wave from the base station apparatus, and a terminal apparatus (not illustrated) mounted in a vehicle or carried by a person in the vehicle. It is assumed that the roadside station 1502 and the roadside station 1503 each use a method in which multiple antennas are used, for example, and can estimate whether the terminal apparatus is approaching or leaving the roadside station. It is assumed that, at this time, a traveling direction of the vehicle is also estimated. Communication between the terminal apparatus and each of the roadside stations 1502 and 1503 is not particularly limited, and cellular direct communication or a communication system for transportation facilities, different from the cellular communication system, that is typically referred to as a Dedicated Short Range Communications (DSRC). Furthermore, the roadside station 1502 and the roadside station 1503 may operate as small-scale base station apparatuses. In this case, the terminal apparatus is required to simultaneously communicate with multiple base station apparatuses.

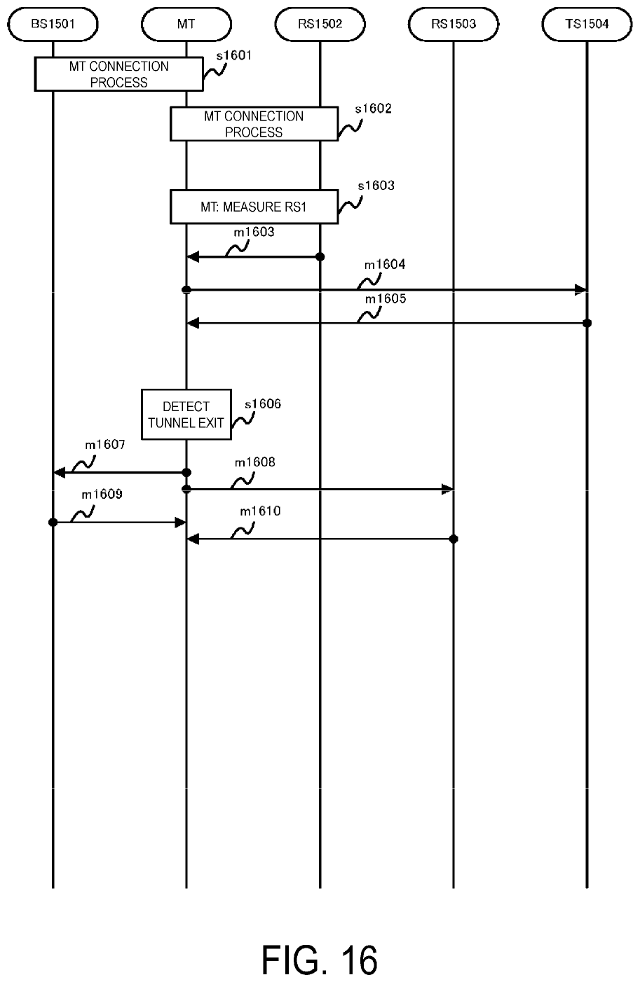

In the present embodiment, the connection destination during communication varies depending on the position of the terminal apparatus. The terminal apparatus connects to the base station apparatus 1501 and the roadside station 1502 at a periphery 1505 of the roadside station 1502, connects to the in tunnel station 1504 in a blocking space 1507, and connects to the base station apparatus 1501 and the roadside station 1503 at a periphery 1506 of the roadside station 1503. The terminal apparatus may move from the range 1505 through the inside of tunnel 1507 into the range 1506. In such a case, a trigger is generated at the time when the movement of the terminal apparatus from the range 1505 to the inside of tunnel 1507 is estimated. The trigger activates an operation of switching the connection destination to the in tunnel station 1504 and a sequence of switching, after a predetermined period of time, the connection destination to the base station apparatus 1501 and the roadside station 1503. FIG. 16 illustrates an example of the sequence.

FIG. 16 is a diagram illustrating an example handover operation of each apparatus according to the present embodiment. In FIG. 16, the terminal apparatus is powered on in the range 1505. In a step s1601, the terminal apparatus (MT) performs a process of connecting to the base station apparatus 1501 (BS1501). In a case that the terminal apparatus (MT) is powered on at another location and moves into the range 1505 while being connected to the base station apparatus 1501, the process may proceed to a step s1602 without a step s1601. Subsequently, in a step s1602, the terminal apparatus performs a process of connecting to the roadside station 1502 (RS1502). The state in which the step s1601 and step s1602 are successful is similar to a state in which the terminal apparatus is located within the range 1505 as illustrated in FIG. 15.

In a step s1603, the terminal apparatus periodically reports reception quality to the roadside station 1502. The roadside station 1502, having received the report of the reception quality, estimates the position and traveling direction of the terminal apparatus, and predicts the movement of the terminal apparatus to the inside of tunnel 1507. The roadside station 1502 then transmits a message m1603 to the terminal apparatus to indicate to the terminal apparatus to change the connection destination to the in tunnel station 1504. The message m1603 may further include an indication to change, at a predetermined point of time, the connection destination to the base station apparatus 1501 and the roadside station 1503. The predetermined point of time may be a relative time from the current point of time or an absolute time. Furthermore, the predetermined point of time may be determined based on an average passage time of the vehicles passing through the tunnel, may be based on an estimated value of a traveling speed of the terminal apparatus in a case that the traveling speed can be estimated by the roadside station 1502, or may be based on information obtained from another system such as Intelligent Transport System (ITS). The terminal apparatus, having received the message m1603, transmits a message m1604 to the in tunnel station 1504 (TS 1504) to request a connection to the in tunnel station 1504. The terminal apparatus may transmit the message m1604 after confirming reception of a signal from the in tunnel station 1504 or may transmit the message m1604 without such a confirmation and repeatedly transmit the message m1604 until the terminal apparatus receives a response from the in tunnel station. The in tunnel station 1504, having received the message m1604, transmits a message m1605 to the terminal apparatus to notify that the in tunnel station 1504 has accepted the connection of the terminal apparatus. The terminal apparatus, having received the message m1605, configures the connection destination to the in tunnel station 1504 to communicate with the in tunnel station 1504.

In a step s1606, the terminal apparatus estimates a timing to move out of the tunnel. The timing may be estimated by using a point of time when the connection destination is changed, the point of time being included in the message m1604. In a case that the speed of traveling through the tunnel is expected to change, a timing may be used that is determined by taking into account the information included in the message m1605 and the change of the speed. Furthermore, the timing may be estimated by using, in addition, a change of quality of a signal transmitted from the in tunnel station. The terminal apparatus may receive, from the in tunnel station, information that can be used to estimate the timing to move out of the tunnel, which is, for example, information about the average speed of the vehicle traveling through the tunnel and a change of the speed of the vehicle, and may use the information to estimate the timing to move out of the tunnel. At the timing estimated in the step s1604, the terminal apparatus transmits a message m1607 to the base station apparatus 1501 to perform a connectivity request to the base station apparatus 1501. Furthermore, the terminal apparatus transmits a message m1608 to the roadside station 1503 to perform a connectivity request to the roadside station 1503. The message m1607 and the message m1608 may be repeatedly transmitted until the transmission succeeds. The base station apparatus 1501, having received the message m1607, transmits a message m1609 to the terminal apparatus to notify that the base station apparatus 1501 has accepted the connectivity request. The roadside station 1503, having received the message m1608, transmits a message m1610 to the terminal apparatus to notify that the roadside station 1503 has accepted the connectivity request.

Performing, by each apparatus, the sequence in FIG. 16 as described above allows the handover procedure for multiple apparatuses to be performed at a predetermined point of time by using one trigger for handover. In FIG. 16, in a step s1603, the report of reception quality is transmitted to the roadside station 1502. However, the report may be transmitted to the base station apparatus 1501. Furthermore, the roadside station 1502 may notify the base station apparatus 1501 of the estimated position, traveling direction, and the like of the terminal apparatus. In a case that the base station apparatus 1501 can recognize that the terminal apparatus is approaching the inside of tunnel 1507, by a method, for example, in which information is obtained from the roadside station 1502, the base station apparatus 1501 may transmit the message m1603 to the terminal apparatus. Note that multiple techniques of the techniques described in the embodiments from the first embodiment to the fourth embodiment can be applied to the terminal apparatus, the base station apparatus, the access point, and the wireless tag.

In the above-described embodiments, the functions are assigned to the controller, access point, and electromagnetic sensor. However, the configurations of the apparatuses are not limited to the configurations illustrated in the embodiments. For example, the functions of the controller may be included in the access point or the functions of the controller may be included in the electromagnetic sensor.

A program running on an apparatus according to the present invention may serve as a program that controls a Central Processing Unit (CPU) and the like to cause a computer to operate in such a manner as to realize the functions of the above-described embodiment according to the present invention. Programs or information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiments according to the present invention may be recorded in a computer readable recording medium. The program recorded on the recording medium may be realized by causing a computer system to read and perform the program. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically holding the program for a short time, or any other computer readable recording medium.

Furthermore, each functional block or various characteristics of the apparatuses used in the above-described embodiments may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, a processor of known type, a controller, a micro-controller, or a state machine. The above-mentioned electric circuits may each be constituted of a digital circuit or constituted of an analog circuit. Furthermore, in a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiments, each of the apparatuses is described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

The present invention can be utilized for a communication apparatus and a control method for the communication apparatus.

The present international application claims priority based on JP 2016-207656 filed on Oct. 24, 2016, and all the contents of JP 2016-207656 are incorporated in the present international application by reference.

### REFERENCE SIGNS LIST

101, 102 Access point
103 Base station apparatus
104 Terminal apparatus
105, 106 Wireless tag
107 Indoor space
201 Peripheral space of terminal apparatus
501 Interface unit of cellular communication system
502 Interface unit of first private communication system
503 Interface unit of second private communication system
504 Communication controller
505 Controller
506 Operation unit
507 Display unit
511 WAN interface unit
512 Interface unit of first private communication system
513 Interface unit of second private communication system
514 Communication controller
515 Controller
516 Operation unit
521 Interface unit of second private communication system
522 Communication controller
523 Controller
524 Operation unit
1101, 1102 Terminal apparatus
1103 to 1107 Wireless tag
1201, 1202 Terminal apparatus
1203 Base station apparatus
1204 Access point
1205 Coverage of wireless LAN using 2.4 GHz band
1206 Coverage of wireless LAN using 5 GHz band
1301 Interface unit of cellular communication system
1302 5 GHz band wireless LAN system interface unit
1303 2.4 GHz band wireless LAN system interface unit
1304 Communication controller
1305 Controller
1306 Operation unit
1307 Display unit
1311 WAN interface unit
1312 5 GHz band wireless LAN system interface unit
1313 2.4 GHz band wireless LAN system interface unit
1314 Communication controller
1315 Controller
1316 Operation unit
1501 Base station apparatus
1502, 1503 Roadside station
1504 In tunnel station
1505, 1506 Coverage of roadside station
1507 Coverage of in tunnel station

1. A communication apparatus for communicating with a plurality of communication apparatuses, the communication apparatus comprising:
a communication controller configured to control at least one communication system used for communication with the plurality of communication apparatuses; and
an interface unit configured to transmit and/or receive a signal according to the communication system,
wherein in a case that a trigger for handover occurs in one of the plurality of communication apparatuses, the communication controller initiates a handover process of at least two of the plurality of communication apparatuses.

2. The communication apparatus according to claim 1, wherein
the at least one communication system comprises a plurality of communication systems, and at least one of the at least two of the communication apparatuses of which the handover process is initiated, uses different communication systems before and after the handover process.

3. The communication apparatus according to claim 1, wherein
in a case that the trigger for handover occurs and a connection destination to be connected after the handover process is determined, whether the plurality of communication systems are available is determined, and the connection destination that uses an available system is selected.

4. The communication apparatus according to claim 1, wherein
in a case that the trigger for handover occurs, at least two of the plurality of communication apparatuses are selected based on a predetermined group.

5. The communication apparatus according to claim 1, wherein
in a case that the trigger for handover occurs to change a connection destination of the communication apparatus from a first communication apparatus included in the plurality of communication apparatuses to a second communication apparatus included in the plurality of communication apparatuses, the communication controller initiates the handover process of a third communication apparatus, among the plurality of communication apparatuses, that is connected to at least one of the second communication apparatus and the first communication apparatus.

6. The communication apparatus according to claim 1, wherein
in a case that the trigger for handover occurs to change a connection destination of a first communication apparatus included in the plurality of communication apparatuses to the communication apparatus, and information about a second communication apparatus, included in the plurality of communication apparatuses, that connects to the first communication apparatus is received from the interface unit, the communication controller accepts a connectivity request transmitted from the second communication apparatus to the communication apparatus.

7. The communication apparatus according to claim 1, wherein
in a case that the trigger for handover occurs to change a connection destination of the communication apparatus to a first communication apparatus included in the plurality of communication apparatuses, the communication controller initiates, after a predetermined period of time elapses, the handover process of at least one of a second communication apparatus and a third communication apparatus included in the plurality of communication apparatuses.

8. The communication apparatus according to claim 1, wherein
in a case that the trigger for handover occurs for a first communication apparatus connected to the communication apparatus to change a connection destination of the first communication apparatus to a second communication apparatus, the communication controller initiates the handover process of connecting, to the first communication apparatus, a third communication apparatus connected to the communication apparatus.

9. The communication apparatus according to claim 1, wherein
in a case that the trigger for handover occurs for the interface unit to change a connection destination to a first communication apparatus included in the plurality of communication apparatuses, the communication controller initiates the handover process of connecting, to the first communication apparatus, the communication apparatus and a second communication apparatus connected to the communication apparatus.

10. The communication apparatus according to claim 1, wherein
in a case that the trigger for handover occurs for a first communication apparatus, included in the plurality of communication apparatuses, that is a connection destination of the communication apparatus, to change a connection destination of the first communication apparatus to a second communication apparatus, the communication controller initiates the handover process of changing the connection destination of the communication apparatus to the second communication apparatus.

11. A control method used in a communication apparatus for communicating with a plurality of communication apparatuses, the control method comprising the step of:
initiating, in a case that a trigger for handover occurs in one of the plurality of communication apparatuses, a handover process of at least two of the plurality of communication apparatuses.
